(19) United States
(12) Patent Application Publication
(10) Pub. No.: US 2013/0281078 A1
(43) Pub. Date: Oct. 24, 2013

(54) MOBILE COMMUNICATION DEVICE, STORAGE MEDIUM, AND METHOD FOR CONTROLLING COMMUNICATIONS OF THE MOBILE COMMUNICATION DEVICE

(71) Applicant: CHI MEI COMMUNICATION SYSTEMS, INC., New Taipei (TW)

(72) Inventor: YEN-TING LIU, New Taipei (TW)

(73) Assignee: CHI MEI COMMUNICATION SYSTEMS, INC., New Taipei (TW)

(21) Appl. No.: 13/858,047

(22) Filed: Apr. 7, 2013

(30) Foreign Application Priority Data
Apr. 19, 2012 (TW) 101114008

(51) Int. Cl. H04W 8/22

(52) U.S. Cl. CPC H04W 8/22
USPC 455/418

(57) ABSTRACT

A method for controlling communication of a mobile communication device that connects to one or more slave devices. Data is written into a storage system of the mobile communication device, and the method determines whether an incoming call is received by the mobile communication device or whether an outgoing call is dialed by the mobile communication device according to the monitored data. When the incoming call is received by the mobile communication device, the method answers the incoming call using either the mobile communication device or one of the slave devices according to data stored in the storage system. The method further dials the outgoing call using the mobile communication device according to the data stored in the storage system.

### BACKGROUND

1. Technical Field

Embodiments of the present disclosure relate to communication control systems and methods, and more particularly to controlling communications of a mobile communication device.

2. Description of Related Art

Mobile communication devices can communicate with a base station. A user may use a mobile communication device to make a phone call and answer a phone call. The user may own one or more mobile communication devices. All mobile communication devices may transmit data to and from each other through a wireless network. However, one mobile communication device cannot control other mobile communication devices to make a phone call or answer a phone call. Therefore, there is room for improvement in the art.

### BRIEF DESCRIPTION OF THE DRAWINGS

FIG. 1 is a block diagram of one embodiment of a mobile communication device including a communication control system.

FIG. 2 is a block diagram of function modules of the communication control system in the mobile communication device of FIG. 1.

FIG. 3 is a flowchart of one embodiment of a method for controlling communications of the mobile communication device of FIG. 1.

FIG. 4A is a schematic diagram illustrating an answering table that records incoming calls.

FIG. 4B is a schematic diagram illustrating a dialing table that records outgoing calls.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage system. The non-transitory computer-readable storage medium may include CDs, DVDs, BLU-RAY, flash memory, and hard disk drives.

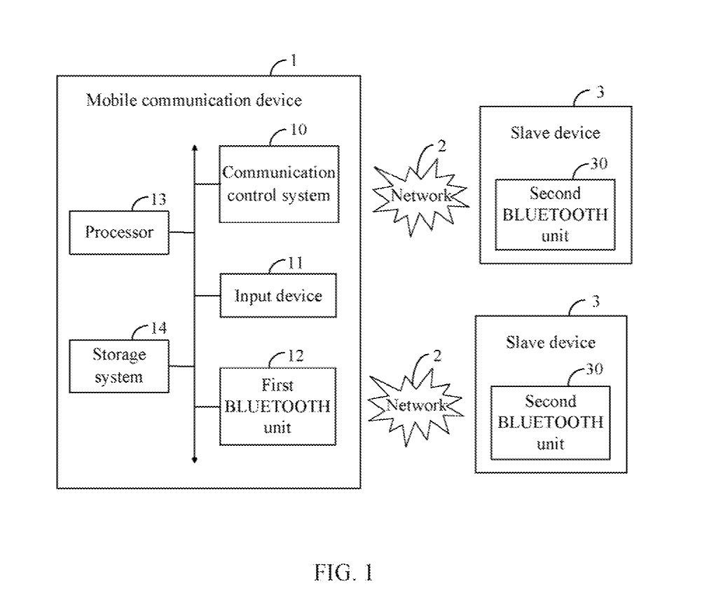

FIG. 1 is a block diagram of one embodiment of a mobile communication device 1 including a communication control system 10. The mobile communication device 1 is an electronic device that communicates with a base station (not shown in FIG. 1), and may be a mobile phone, a notebook computer, or a personal digital assistant (PDA), for example. The mobile communication device 1 connects to one or more slave devices 3 through a network 2. As shown in FIG. 1, the mobile communication device 1 connects to two slave devices 3. The network 2 may be an Internet, an intranet, an ethernet, or any other relevant network. Each of the slave devices 3 is an electronic device that interacts with a user, and may be a mobile phone, a notebook computer, or a PDA, for example.

The mobile communication device 1 includes an input device 11, and a first BLUETOOTH unit 12. The input device 11 receives data input by the user, and the mobile communication device 1 can communicate with each of the slave devices 3 wirelessly through the first BLUETOOTH unit 12. In one embodiment, the first BLUETOOTH unit 12 supports a hands-free profile function and a headset profile function. Each of the slave devices 3 includes a second BLUETOOTH unit 30 that connects with the first BLUETOOTH unit 12 to exchange data between the mobile communication device 1 and each of the slave devices 3.

The communication control system 10 controls one of the slave devices 3 to answer an incoming call which is made to the mobile communication device 1, and controls the mobile communication device 1 to dial an outgoing call with an outgoing number that is input to the mobile communication device 1 by one of the slave devices 3.

The mobile communication device 1 further includes a processor 13 and a storage system 14. The processor 13 executes one or more computerized codes and other applications for the mobile communication device 1, to provide functions of the communication control system 10. The storage system 14 stores data of the mobile communication device 1. In one embodiment, the storage system 14 may be an internal storage device, such as a random access memory (RAM) for temporary storage of information, and/or a read only memory (ROM) for permanent storage of information. In some embodiments, the storage system 14 may also be an external storage device, such as an external hard disk, a storage card, or a data storage medium.

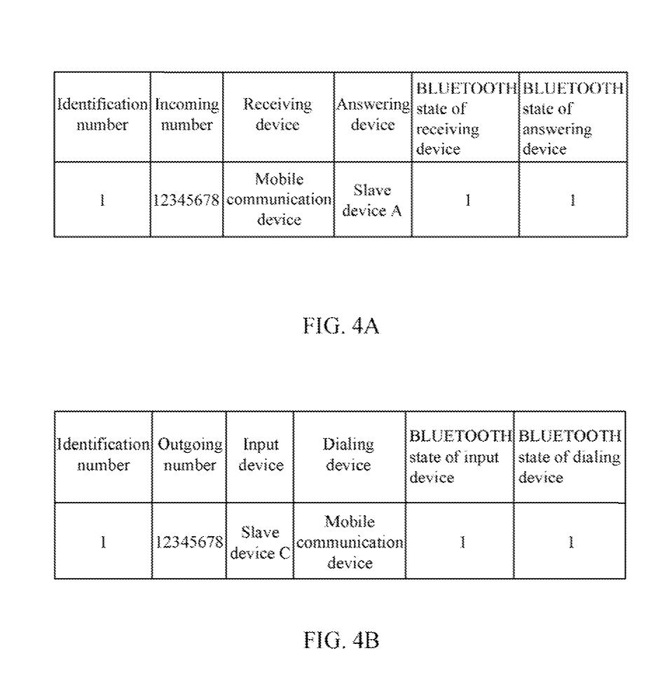

The storage system 14 stores an answering table and a dialing table. In one example with respect to FIG. 4A, the answering table is used to record details of all incoming calls, whether answered by the mobile communication device 1 or by any of the slave devices 3. Referring to FIG. 4B, the dialing table records details of calls made (outgoing calls) whether inputted by the mobile communication device 1 or by any of the slave devices 3.

In FIG. 4A, the answering table may include an identification number of an incoming call, an incoming number of the incoming call, a receiving device of the incoming call, an answering device of the incoming call, a BLUETOOTH state of the receiving device, and a BLUETOOTH state of the answering device. The identification number of the incoming call labels and identifies the incoming call. The receiving device is the particular mobile communication device 1 that receives the incoming call, and communicates with the base station. The answering device is the mobile communication device 1 of a user or a slave device 3 of a user which picks up (answers) the incoming call. For example, phone A makes a call to phone B, the phone B rings, and phone C is used by the user to answer the call from the phone A. In this situation, the phone B is the receiving device, and the phone C is the answering device. BLUETOOTH state includes an open state and a closed state. When the value of the BLUETOOTH state is one, it indicates that the BLUETOOTH state is the open state. The open state is a state that the first BLUETOOTH unit 12 of the mobile communication device 1 or the second BLUETOOTH unit 30 of one of the slave devices 3 is turned on. When the value of the BLUETOOTH state is zero, it indicates that the BLUETOOTH state is the closed state. The closed state is a state that the first BLUETOOTH unit 12 of the mobile communication device 1 or the second BLUETOOTH unit 30 of one of the slave devices 3 is closed.

In FIG. 4B, the dialing table may include an identification number of an outgoing call, an outgoing number of the outgoing call, an input device of the outgoing call, a dialing device of the outgoing call, a BLUETOOTH state of the input device, and a BLUETOOTH state of the dialing device. The identification number of the outgoing call labels and identifies the outgoing call. The input device is the mobile communication device 1 or one of the slave devices 3 into which the user inputs the outgoing number for the outgoing call. The dialing device is the mobile communication device 1 that, communicating with the base station, actually makes a call to the outgoing number. For example, the user inputs into phone D an outgoing telephone number of a phone F, and connects the called phone F with a phone E, the user then talks to the phone F through the phone E. In other words, the phone F displays a telephone number of the phone E, not of the phone D, and the phone D is just an initial input device. In this situation, the phone D is the input device, and the phone E is used as the dialing and talking device to the outside.

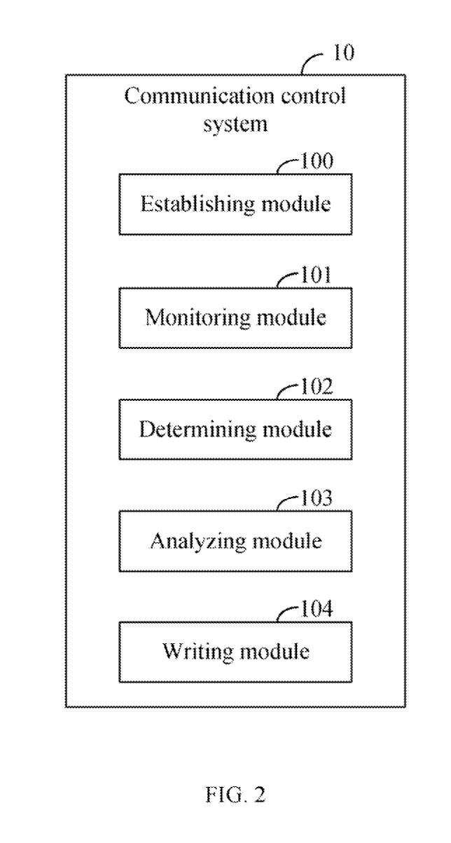

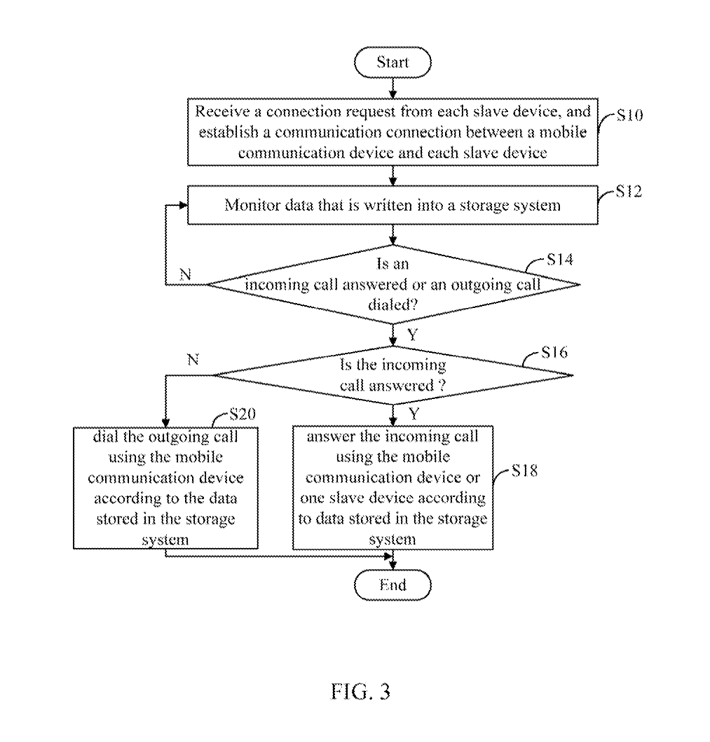

FIG. 2 is a block diagram of function modules of the communication control system 10 in the mobile communication device 1 of FIG. 1. In one embodiment, the communication control system 10 may include an establishing module 100, a monitoring module 101, a determining module 102, an analyzing module 103, and a writing module 104. The modules 100-104 comprise computerized codes in the form of one or more programs that are stored in the storage system 14 and executed by the processor 13 to provide functions for the modules, the functions are illustrated in FIG. 3.

FIG. 3 is a flowchart of one embodiment of a method for controlling communication of the mobile communication device 1 of FIG. 1. Depending on the embodiment, additional steps may be added, others removed, and the ordering of the steps may be changed.

In step S10, the establishing module 100 receives a connection request from each of the slave devices 3, and establishes a communication connection between the mobile communication device 1 and each the slave devices 3 according to the connection request. In one embodiment, the network 2 is a WIFI intranet, and the mobile communication device 1 supports a WIFI hotspot function. The WIFI hotspot ensures a communication connection to each of the slave devices 3 connecting to the mobile communication device 1 through the WIFI intranet. BLUETOOTH states of the mobile communication device 1 and of each of the slave devices 3 are the closed state. The closed state is a state that the first BLUETOOTH unit 12 of the mobile communication device 1 or the second BLUETOOTH unit 30 of one of the slave devices 3 is closed.

In step S12, the monitoring module 101 monitors data that is written into the storage system 14. When the user answers an incoming call using the mobile communication device 1 or one of the slave devices 3, the incoming number of the incoming call, the receiving device of the incoming call, and the answering device of the incoming call are written into the answering table, as shown in FIG. 4A. When the user dials an outgoing call using the mobile communication device 1, the outgoing number of the outgoing call, the input device of the outgoing call, and the dialing device of the outgoing call are written into the dialing table, as shown in FIG. 4B.

In step S14, the determining module 102 determines whether the incoming call is received by the mobile communication device for whether the outgoing call is dialed by the mobile communication device 1, according to the monitored data in step S12. If the incoming call is received by the mobile communication device 1 or the outgoing call is dialed by the mobile communication device 1, step S16 is implemented. If the incoming call is not received by the mobile communication device 1 and the outgoing call is not dialed by the mobile communication device 1, step S12 is repeated. In one embodiment, when the monitoring module 101 monitors that the data is written into the answering table of the storage system 14, the determining module 102 determines that the incoming call is received by the mobile communication device 1. When the monitoring module 101 monitors that the data is written into the dialing table of the storage system 14, the determining module 102 determines that the outgoing call is dialed by the mobile communication device 1. When the monitoring module 101 monitors that no data is written into the answering table of the storage system 14 or into the dialing table of the storage system 14, the determining module 102 determines that the incoming call is not received by the mobile communication device 1 and that the outgoing call is not dialed by the mobile communication device 1.

In step S16, the determining module 102 determines whether the incoming call is received by the mobile communication device 1. If the incoming call is received by the mobile communication device 1, step S18 is implemented. If the outgoing call is dialed by the mobile communication device 1, step S20 is implemented.

In step S18, the analyzing module 103 analyzes and determines an answering mode for answering the incoming call according to the data in the answering table of the storage system 14, and answers the incoming call using either the mobile communication device 1 or one of the slave devices 3 according to the answering mode. In one embodiment, the answering mode may be either a direct answer mode or an indirect answer mode. If the receiving device and the answering device are the same, the analyzing module 103 analyzes and determines that the answering mode is the direct answer mode. If the receiving device and the answering device are not the same, the analyzing module 103 analyzes and determines that the answering mode is the indirect answer mode.

When the answering mode is the direct answer mode, the analyzing module 103 controls the mobile communication device 1 to pick up and answer the incoming call. When the answering mode is the indirect answer mode, the analyzing module 103 turns on the first BLUETOOTH unit 12 of the mobile communication device 1 and a second BLUETOOTH unit 30 of one of the slave devices 3 for the purpose of answering the incoming call. As shown in FIG. 4A, the answering slave device 3 is slave device A. The analyzing module 103 further connects the mobile communication device 1 with the answering slave device 3 through the first BLUETOOTH unit 12 of the mobile communication device 1 and the second BLUETOOTH unit 30 of the answering slave device 3, and controls the answering slave device 3 to pick up and answer the incoming call.

After the first BLUETOOTH unit 12 of the mobile communication device 1 and the second BLUETOOTH unit 30 of the answered slave device 3 are connected, the writing module 104 change values of BLUETOOTH states of the mobile communication device 1 and of the answering slave device 3 to the same value of one. After the incoming call is ended, the first BLUETOOTH unit 12 of the mobile communication device 1 and the second BLUETOOTH unit 30 of the answering slave device 3 are closed, and the writing module 104 changes values of the BLUETOOTH states of the mobile communication device 1 and the answering slave device 3 to the same value of zero.

In step S20, the analyzing module 103 analyzes a dialing mode to dial the outgoing call, according to the data in the dialing table of the storage system 14, and dials the outgoing call using the mobile communication device 1 according to the dialing mode. In one embodiment, the dialing mode may be either a direct dialing mode or an indirect dialing mode. If the input device and the dialing device are the same, the analyzing module 103 analyzes that the dialing mode is the direct dialing mode. If the input device and the dialing device are not the same, the analyzing module 103 analyzes that the dialing mode is the indirect dialing mode.

When the dialing mode is the direct dialing mode, the analyzing module 103 controls the mobile communication device 1 to actually dial the outgoing call. When the dialing mode is the indirect dialing mode, the analyzing module 103 turns on the first BLUETOOTH unit 12 of the mobile communication device 1 and a second BLUETOOTH unit 30 of one of the slave devices 3 for inputting the outgoing call. As shown in FIG. 4B, the inputting slave device 3 is slave device C. The analyzing module 103 further connects the mobile communication device 1 with the inputting slave device 3 through the first BLUETOOTH unit 12 of the mobile communication device 1 and the second BLUETOOTH unit 30 of the inputting slave device 3. The analyzing module 103 further receives the outgoing number that the inputting slave device 3 inputs, and controls the mobile communication device 1 to dial the outgoing call using the outgoing number of the inputting slave device 3.

After the first BLUETOOTH unit 12 of the mobile communication device 1 and the second BLUETOOTH unit 30 of the inputting slave device 3 are turned on, the writing module 104 changes values of BLUETOOTH states of the mobile communication device 1 and the inputting slave device 3 to the same value of one. After the outgoing call is ended, the first BLUETOOTH unit 12 of the mobile communication device 1 and the second BLUETOOTH unit 30 of the inputting slave device 3 are closed, and the writing module 104 changes values of the BLUETOOTH states of the mobile communication device 1 and the inputting slave device 3 to the same value of zero.

In the present disclosure, when the mobile communication device 1 and the one or more slave devices 3 establish a communication connection, the user can answer the incoming call and dial the outgoing call conveniently through either the mobile communication device 1 or one or more slave devices 3. Specifically, the user can answer an incoming call through one of the slave devices 3, where the incoming call is received by the mobile communication device 1. The user can dial an outgoing call through the mobile communication device 1, where the outgoing call is actually inputted by one of the slave devices 3.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included within the scope of this disclosure and the described inventive embodiments, and the present disclosure is protected by the following claims.

What is claimed is:

1. A computerized-method controlling communication of a mobile communication device that connects to one or more slave devices, the method comprising:
(a) receiving a connection request from each of the slave devices, and establishing a communication connection between the mobile communication device and each of the slave devices according to the connection request;
(b) monitoring data that is written into a storage system of the mobile communication device;
(c) determining whether an incoming call is received by the mobile communication device or whether an outgoing call is dialed by the mobile communication device according to the monitored data;
(d) answering the incoming call using the mobile communication device or one of the slave devices according to data stored in the storage system when the incoming call is received by the mobile communication device; and
(e) dialing the outgoing call using the mobile communication device according to the data stored in the storage system.

2. The method as claimed in claim 1, wherein the storage system stores an answering table and a dialing table.

3. The method as claimed in claim 2, wherein the step (c) further comprises:
determining whether the data is written into the answering table or the dialing table;
determining that the incoming call is received by the mobile communication device when the data is written into the answering table;
determining that the outgoing call is dialed by the mobile communication device when the data is written into the dialing table; and
determining that the incoming call is not received by the mobile communication device and that the outgoing call is not dialed by the mobile communication device when no data is written into the answering table or the dialing table.

4. The method as claimed in claim 1, wherein the step (d) further comprises:
determining whether a receiving device of the incoming call and an answering device of the incoming call are the same;
controlling the mobile communication device to pick up and answer the incoming call when the receiving device of the incoming call and the answering device of the incoming call are the same;
turning on a first BLUETOOTH unit of the mobile communication device and a second BLUETOOTH unit of one of the slave devices for answering the incoming call when the receiving device of the incoming call and the answering device of the incoming call are not the same;
connecting the mobile communication device with the slave device through the first BLUETOOTH unit of the mobile communication device and the second BLUETOOTH unit of the slave device; and
controlling the slave device to pick up and answer the incoming call.

5. The method as claimed in claim 1, wherein the step (e) further comprises:
determining whether an input device of the outgoing call and a dialing device of the outgoing call are the same;
controlling the mobile communication device to dial the outgoing call when the input device of the outgoing call and the dialing device of the outgoing call are the same;
turning on a first BLUETOOTH unit of the mobile communication device and a second BLUETOOTH unit of one of the slave devices for inputting the outgoing call when the input device of the outgoing call and the dialing device of the outgoing call are different;
connecting the mobile communication device with the slave device through the first BLUETOOTH unit of the mobile communication device and the second BLUETOOTH unit of the slave device;
receiving an outgoing number that the slave device inputs; and
controlling the mobile communication device to dial the outgoing call using the outgoing number of the slave device.

6. A non-transitory computer readable storage medium storing a set of instructions, when executed by at least one processor of a mobile communication device, cause the at least one processor to perform a method for controlling communication of the mobile communication device that connects to one or more slave devices, the method comprising:
(a) receiving a connection request from each of the slave devices, and establishing a communication connection between the mobile communication device and each of the slave devices according to the connection request;
(b) monitoring data that is written into a storage system of the mobile communication device;
(c) determining whether an incoming call is received by the mobile communication device or whether an outgoing call is dialed by the mobile communication device according to the monitored data;
(d) answering the incoming call using the mobile communication device or one of the slave devices according to data stored in the storage system when the incoming call is received by the mobile communication device; and
(e) dialing the outgoing call using the mobile communication device according to the data stored in the storage system.

7. The storage medium as claimed in claim 6, wherein the storage system stores an answering table and a dialing table.

8. The storage medium as claimed in claim 7, wherein the step (c) further comprises:
determining whether the data is written into the answering table or the dialing table;
determining that the incoming call is received by the mobile communication device when the data is written into the answering table;
determining that the outgoing call is dialed by the mobile communication device when the data is written into the dialing table; and
determining that the incoming call is not received by the mobile communication device and that the outgoing call is not dialed by the mobile communication device when no data is written into the answering table or the dialing table.

9. The storage medium as claimed in claim 6, wherein the step (d) further comprises:
determining whether a receiving device of the incoming call and an answering device of the incoming call are the same;
controlling the mobile communication device to pick up and answer the incoming call when the receiving device of the incoming call and the answering device of the incoming call are the same;
turning on a first BLUETOOTH unit of the mobile communication device and a second BLUETOOTH unit of one of the slave devices for answering the incoming call when the receiving device of the incoming call and the answering device of the incoming call are not the same;
connecting the mobile communication device with the slave device through the first BLUETOOTH unit of the mobile communication device and the second BLUETOOTH unit of the slave device; and
controlling the slave device to pick up and answer the incoming call.

10. The storage medium as claimed in claim 6, wherein the step (e) further comprises:
determining whether an input device of the outgoing call and a dialing device of the outgoing call are the same;
controlling the mobile communication device to dial the outgoing call when the input device of the outgoing call and the dialing device of the outgoing call are the same;
turning on a first BLUETOOTH unit of the mobile communication device and a second BLUETOOTH unit of one of the slave devices for inputting the outgoing call when the input device of the outgoing call and the dialing device of the outgoing call are different;
connecting the mobile communication device with the slave device through the first BLUETOOTH unit of the mobile communication device and the second BLUETOOTH unit of the slave device;
receiving an outgoing number that the slave device inputs; and
controlling the mobile communication device to dial the outgoing call using the outgoing number of the slave device.

11. A mobile communication device, comprising:
a storage system;
at least one processor; and
one or more programs that are stored in the storage system and executed by the at least one processor, the one or more programs comprising instructions to:
receive a connection request from each slave device, and establish a communication connection between the mobile communication device and the slave device according to the connection request, wherein the mobile communication device connects to one or more slave devices;
monitor data that is written into the storage system;
determine whether an incoming call is received by the mobile communication device or whether an outgoing call is dialed by the mobile communication device according to the monitored data;
answer the incoming call using the mobile communication device or one of the slave devices according to data stored in the storage system when the incoming call is received by the mobile communication device; and
dial the outgoing call using the mobile communication device according to the data stored in the storage system.

12. The mobile communication device as claimed in claim 11, wherein the storage system stores an answering table and a dialing table.

13. The mobile communication device as claimed in claim 12, wherein the determining comprising instructions to:
determine whether the data is written into the answering table or the dialing table;
determine that the incoming call is received by the mobile communication device when the data is written into the answering table;
determine that the outgoing call is dialed by the mobile communication device when the data is written into the dialing table; and
determine that the incoming call is not received by the mobile communication device and that the outgoing call is not dialed by the mobile communication device when no data is written into the answering table or the dialing table.

14. The mobile communication device as claimed in claim 11, wherein the incoming call is answered by instructions to:
determine whether a receiving device of the incoming call and an answering device of the incoming call are the same;
control the mobile communication device to pick up and answer the incoming call when the receiving device of the incoming call and the answering device of the incoming call are the same;
turn on a first BLUETOOTH unit of the mobile communication device and a second BLUETOOTH unit of one of the slave devices for answering the incoming call when the receiving device of the incoming call and the answering device of the incoming call are not the same;
connect the mobile communication device with the slave device through the first BLUETOOTH unit of the mobile communication device and the second BLUETOOTH unit of the slave device; and
control the slave device to pick up and answer the incoming call.

15. The mobile communication device as claimed in claim 11, wherein the outgoing call is dialed by instructions to:
determine whether an input device of the outgoing call and a dialing device of the outgoing call are the same;
control the mobile communication device to dial the outgoing call when the input device of the outgoing call and the dialing device of the outgoing call are the same;
turn on a first BLUETOOTH unit of the mobile communication device and a second BLUETOOTH unit of one of the slave devices for inputting the outgoing call when the input device of the outgoing call and the dialing device of the outgoing call are different;
connect the mobile communication device with the slave device through the first BLUETOOTH unit of the mobile communication device and the second BLUETOOTH unit of the slave device;
receive an outgoing number that the slave device inputs; and
control the mobile communication device to dial the outgoing call using the outgoing number of the slave device.
